(19) United States
(12) Patent Application Publication
(10) Pub. No.: US 2025/0111655 A1
(43) Pub. Date: Apr. 3, 2025

(54) IMAGE GENERATOR FOR TARGETED VISUAL CHARACTERISTICS

(71) Applicant: Zeta Global Corp., New York, NY (US)

(72) Inventors: Ivan Povalyaev, Prague (CZ); Danny Portman, Johns Creek, GA (US)

(21) Appl. No.: 18/902,909

(22) Filed: Sep. 30, 2024

Related U.S. Application Data
(60) Provisional application No. 63/541,777, filed on Sep. 29, 2023.

(51) Int. Cl. G06V 10/774; G06F 40/284; G06T 5/60

(52) U.S. Cl. CPC G06V 10/774; G06F 40/284; G06T 5/60; G06T 2207/20081

(57) ABSTRACT

The subject technology includes an image generator that generates images having specific visual concepts. The image generator uses a selective training process to fine-tune a text to a image generative system. The constrained text to image generative system may be trained to understand multiple custom tokens that embody visual characteristics of images included in fine-tuning datasets. Image generation prompts including one or more custom tokens may be used to condition the image creation process of the constrained text to image system to produce synthetic images having improved specificity, more creativity, and higher performance. Images created by the constrained text to image system may be ranked based on one or more criteria to further refine the created images for one or more specific use cases.

### PRIORITY CLAIM

This patent application claims the benefit of priority, under 35 U.S.C. Section 119(e), to Povalyaev et al, U.S. Provisional Patent Application Ser. No. 63/541,777, entitled “IMAGE GENERATOR FOR TARGETED VISUAL CHARACTERISTICS,” filed on Sep. 29, 2023 (Attorney Docket No. 4525.192PRV), which is hereby incorporated by reference in its entirety.

### TECHNICAL FIELD

The subject matter disclosed herein generally relates to the technical field of generative artificial intelligence (AI) and, more specifically, to techniques for generating images having a particular visual characteristics.

### BACKGROUND

Image generation is an important type of computer vision and machine learning task where synthetic image data is generated in response to seed data. Image generation techniques have traditionally been limited to compilations of portions of images included in training data but recent breakthroughs have produced generative systems that can think beyond what was already present in the training sample and generate new images that are distinct from training examples. Despite the improvements, the images produced using generative techniques share certain characteristics with- and inherit the biases of the training data. The limited diversity of images in training datasets and limited level creative guidance afforded by current methods of interacting with generative systems, prevents current computer image generation techniques from reliably generating images having specific or unique concepts. Current computer image generation techniques also struggle to modify the appearance of objects having one or more predefined concepts and create images that place objects in new scenes or develop new roles the objects.

The technology described herein improves existing image generation techniques by introducing an image generator that trains a generative system to produce images having specific visual characteristics. The image generator may implement a model training process that enables generative AI and other generative systems to create a diverse set of images related to a specific set of user defined visual characteristics. The training process exposes generative systems to the visual characteristics included in a specific set of training images and teaches the generative systems natural language expressions that represent the visual characteristics of the training images. Users may communicate with the generative systems using the learned natural language expressions to create a wide variety of different images that each embody aspects of the visual characteristics associated with the learned expression. The image generator may refine produced images by ranking the quality of the images with regard to specific criteria.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of an image generator, according to various embodiments described herein.

FIG. 7 illustrates aspects of a pre-trained generative model, according to various embodiments described herein.

FIG. 8 illustrates aspects of a constrained generative model, according to various embodiments described herein.

FIG. 9 is a block diagram illustrating aspects of a training process, according to various embodiments described herein.

FIG. 10 is a block diagram illustrating aspects of a runtime process, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The image generator may create synthetic images based on natural language prompts and other text inputs received in a conversational interface. To produce images, the image generator may perform a training process that fine tunes one or more generative systems (e.g., generative adversarial networks (GANs), stable diffusion models, text to image models, and the like). The conversational interface provided by the image generator receives natural language prompts as input. The image generator enables text guided creation of images by orchestrating one or more generative systems to produce specific images based on the text prompts. The produced images are refined by ranking the images according to one or more specific criteria. The refined images are then returned to the user.

The image generator provides multiple improvements over other image generation systems. By teaching image generation systems a new vocabulary for representing visual characteristics, the image generator may create images having a particular style, aesthetic, or other visual characteristic that is difficult to represent textually. The new vocabulary for representing visual characteristics also increases the diversity of the image that may be created by expanding the degrees of creative freedom image generation systems have relative to the image samples in training data. The image generator can create images that modify objects having a particular appearance or setting in the training data using one or more tokens of the learned vocabulary of visual characteristics. Accordingly, the image produced by the image generator are more creative in that they may be more distinct relative to the training data. For example, the image generator may produce images that modify the traditional appearance of an object (e.g., generate an image of a cyclist with cat-like characteristics), give the object a new role, or create a new scene with the object in a new environment (e.g., generate an image of an astronaut in a grocery store). The image generator may also produce images having a particular style or other visual characteristic that is unrecognizable or impossible to describe using traditional vocabulary. For example, the image generator may create images in the style of other images that received a high number of likes, generated a lot of user comments, clicks, or other engagement, sold for a lot of money at art sale, or satisfied one or more other criteria.

The image generator may improve the creativity and precision of other image generation methods by performing a training process that orchestrates multiple components (e.g., databases, applications, generative models, and the like) to produce a constrained generative system that understands a visual vocabulary. The training process may expose the generative system to visual characteristics of images included in a training sample. Each time the training process is completed, the constrained generative system may learn a new token associated with the visual characteristics of the training images. The token may be encoded with an embedding having coronadites within a text embedding space so that the into the generative system may determine a textual meaning for the visual characteristics associated with the token. The training process may be performed multiple times using different images for training data so that the constrained generative system may understand a visual vocabulary including multiple tokens, with each token associated with different visual characteristics. Each of the multiple tokens may be encoded with a different embedding that corresponds to a different textual meaning.

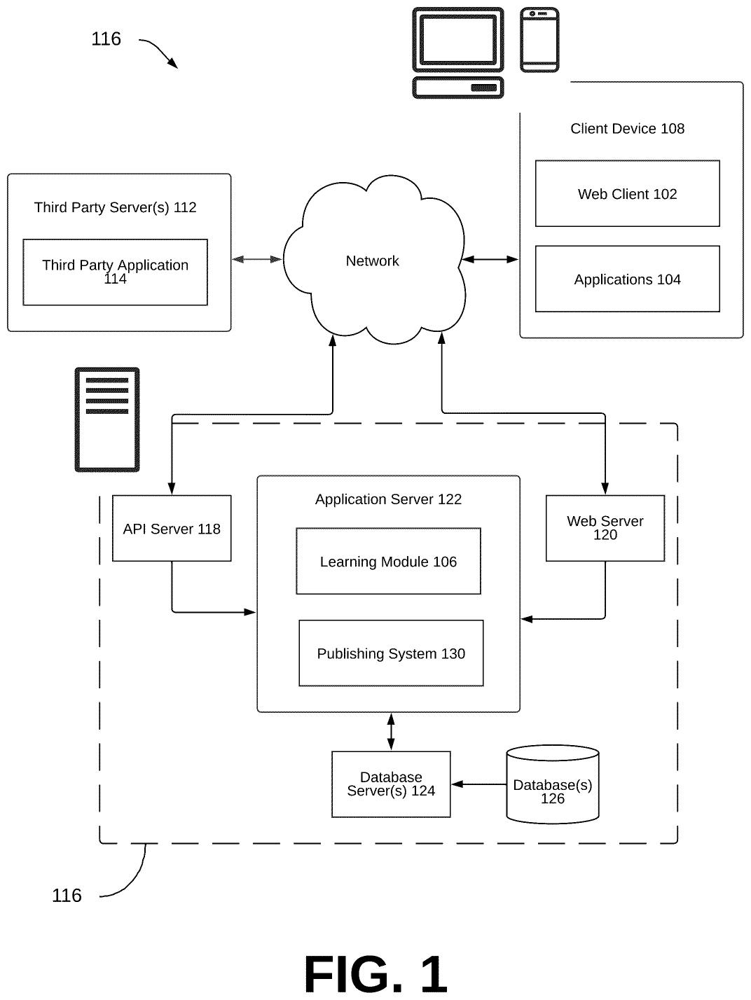

The image generator may be implemented within a learning module included in the SaaS network architecture described in FIG. 1 below so that the image generation functionality may be scaled to generate target images for users across multiple client devices. With reference to FIG. 1, an example embodiment of a high-level SaaS network architecture 100 is shown. A networked system 116 provides server-side functionality via a network 110 (e.g., the Internet or WAN) to a client device 108. A web client 102 and a programmatic client, in the example form of a client application 104, are hosted and execute on the client device 108. The networked system 116 includes an application server 122, which in turn hosts a publication system 106 (such as a demand side platform (DSP), message transfer agent (MTA), and the like) that provides a number of functions and services to the client application 104 that accesses the networked system 116. The client application 104 also provides a number of graphical user interfaces (GUIs) described herein that may be displayed on one or more client devices 108 and may receive inputs thereto to configure an instance of the client application 104 and monitor operations performed by the application server 112. For example, the client application 104 may provide dynamic content generation user interfaces for generating image data (e.g., images, video, three dimensional holograms, and the like) and content items including the generated image data and text content and one or more links, widgets, or other interactive components. The client application 104 may also provide one or more user interfaces for publishing one or more content campaigns that include the generated images. For example, the client application may provide campaign setup user interfaces for selecting campaign configuration settings, content personalization user interfaces for editing image generation prompts and viewing generated images, a campaign monitoring user interface for tracking the performance of content campaign, and the like. The GUIs provided by the client application 104 may present outputs to a user of the client device 108 and receive inputs thereto in accordance with the methods described herein.

The client device 108 enables a user to access and interact with the networked system 116 and, ultimately, the learning module 106. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the learning module 106, which includes components or applications described further below. The application server 122 may also host a publishing system 130 that distributes image data and other content generated by the learning module 106. The application server 122 is, in turn, shown to be coupled to a database server 124 that facilitates access to information storage repositories (e.g., a database 126). In an example embodiment, the database 126 includes storage devices that store information accessed and generated by the learning module 106.

The publishing system 130 may be a demand side platform (DSP), email service provider (ESP) or other system that distributes content digitally over a network. The publishing system may be configured to distribute images generated by the image generator in one or more campaigns that target one or more audiences of consumers. For example, the publishing system 130 may be a DSP that includes an integrated bidding exchange, an online demand side portal accessible to a targeted content provider, and an online supply side portal accessible to a publisher of content on the publication network 110. The bidding exchange may be communicatively coupled to the demand side portal and the supply side portal to display bidding user interfaces on a client device 108. The bidding user interfaces may provide bidstream data including placement data about one or more placements of content available at one or more specified locations or domains on the publication network. The bidstream data may include information about the placements (e.g., the content format, the placement size, the location of the placement within one or more webpages, and the like) and the user who will see the placement (e.g., a device identifier, cookie, IP address, location code, and the like). The demand side portal may analyze the bidstream data to determine consumer attributes of the users that will view the placement (e.g., by matching cookies or other identifiers to a user identifier associated with a user profile in database of consumer attributes). The demand side portal may then determine one or more bids (e.g., whether to bid for a placement or not and an amount to bid) based on the consumer attributes of the user who will view the placement and submit the bids to the integrated bidding exchange. Successful bids are resolved by the integrated bidding exchange and the publication system 130 may present images generated by the image generator of the learning module 106 and other media at the specified location or domain on the publication network 110 the corresponds to the placement. For example, the demand side portal may be configured to reserve, upon resolving of a successful bid from the media provider, the specified location or domain for the placement of media. The demand side portal of the publication system 130 may then publish the piece of media at the reserved placements. Accordingly, the publication system 130 and learning module 106 may work in concert to enable scalable digital media campaigns that include images of a particular subject matter generated by the image generator. The generated images may be customized for the users in one or more audience segments targeted by a campaign. Users accessing the locations including the reserved placements may view and engage with the generated images. In some examples, the publication system 130 is further configured to process a transaction between the content provider and the publisher based on the presentation or a viewing of the targeted content by the consumer, or a third party.

In embodiments having a publication system 130 including an ESP, the ESP and the learning module 106 may work in concert to enable scalable email campaigns that include email messages having images generated by the image generator. The learning module 106 may generate images for different subject matter that target different audience segments and may transmit the targeted generated images to an ESP included in the publication system 130. The ESP may generate email messages that include the generated and transmit the messages to the email addresses of the users in the targeted audience segment.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the learning module 106) via the web interface supported by the web server 120. Similarly, the client application 104 (e.g., a digital marketing “app”) accesses the various services and functions provided by the learning module 106 via the programmatic interface provided by the API server 118. The client application 104 may be, for example, an “app” executing on the client device 108, such as an iOS or Android OS application, to enable a user to access and input data on the networked system 116 in an offline manner and to perform batch-mode communications between the client application 104 and the networked system 116. The client application 104 may also be a web application or other software application executing on the client device 108.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The learning module 106 could also be implemented as a standalone software program, which does not necessarily have networking capabilities.

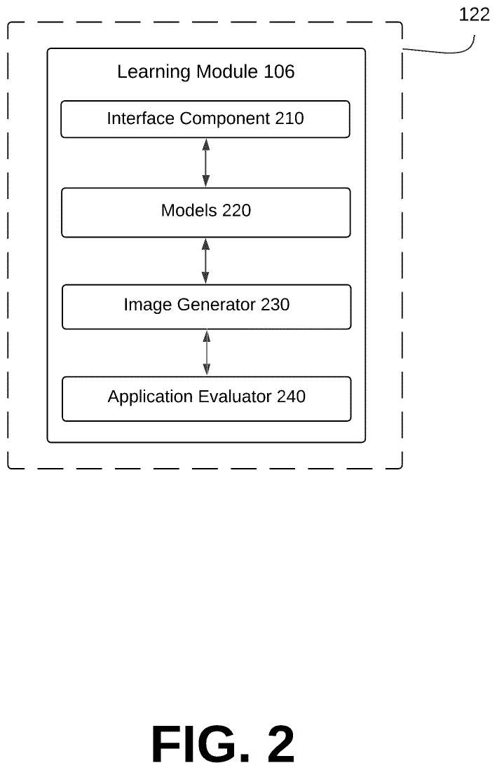

FIG. 2 is a block diagram showing architectural details of a learning module 106, according to some example embodiments. Specifically, the learning module 106 is shown to include an interface component 210 by which the learning module 106 communicates (e.g., over a network 110) with other systems within the SaaS network architecture 100.

The interface component 210 is collectively coupled to one or more campaign configuration components of the publishing system that operate to provide specific aspects of configuring and optimizing generated images provided by the learning module 106 and media campaigns that distribute the images. The campaign configuration components may display one or more content generation user interfaces that may receive inputs including targeting data, subject data, and other image generation instructions. Targeting data may include, for example, one or more audience segments, targeting criteria, and the like and subject data may include, for example, one or more objects, products, services, visual characteristics, and the like to include in the generated images. The interface component 210 may receive the image generation instructions from the campaign configuration components and provide the targeting data, subject data, and/or other instructions to the image generator 230 to guide the image creation process.

To facilitate determining targeting data, the interface component 210 and/or campaign configuration components may be connected to an identity component that resolves an identity for each of target consumers in an audience segment. The identity component may resolve identities for target consumers by using one or more pieces of identity data included in an audience segment or other piece of targeting data. The identity component may match the identity data for each of the target consumers to a record identifier associated with an identity record included in a data cloud. The identity data may include a unique identifier for a consumer, for example, a data_cloud_ID, a name, an physical address, a cookie, a device_ID, an email address, a user_ID, and the like. One or more of the unique identifiers may be encrypted using a hash algorithm (e.g., SHA-256) or other encryption algorithm and the hashed version of the unique identifier may be stored included in content requests and stored in the data cloud.

The interface component 210 may provide a conversational interface that receives natural language prompts for generating images. The natural language prompts may also include text descriptions of images to be created by the image generator. The natural language prompts may also include one or more pieces of targeting data and/or subject data. In various embodiments, users may input the natural language prompts into the conversational interface. The natural language prompts may also be constructed programmatically, for example, by using the campaign configuration components of the publishing system.

The interface component 210 may be collectively coupled to one or more models 220 that operate to provide predictions used to configure content campaigns executed by the publication system 130. The models 220 may include linear regression models, decision trees, neural networks, LMs, and other machine learning and/or artificial intelligence models. An image generator 230 coupled to the models 220 implements a generative system that may generate image data and rank the generated images based on one or more performance criteria. The image generator 230 may perform a training process that to generate a constrained generative system that understands one or more tokens of a visual vocabulary. Each of the tokens may be associated with one or more visual characteristics of images included in a training sample. The operations of the image generator 230 are covered in detail below with reference to the accompanying drawings.

A validation component 240 connected to the image generator 230 reviews the generated images and evaluates the performance of the image generator and generates system to ensure the fined-tuned generative system is performing as trained and not acting in ways that are undesirable by the user or may damage or restrict one or more components of the SaaS network architecture. Image data generated by the image generator 230 may be provided to the interface component 210 for display and/or review in one or more UIs. Image data generated by the image generator 230 may also be included one or more content campaigns published by the publishing system 130.

It should be understood that the learning module 106 may include one or more instances of each of the components. For example, the learning module 106 may include multiple instances of the image generator 230 with each instance being operated to host different generative systems and develop different visual vocabularies.

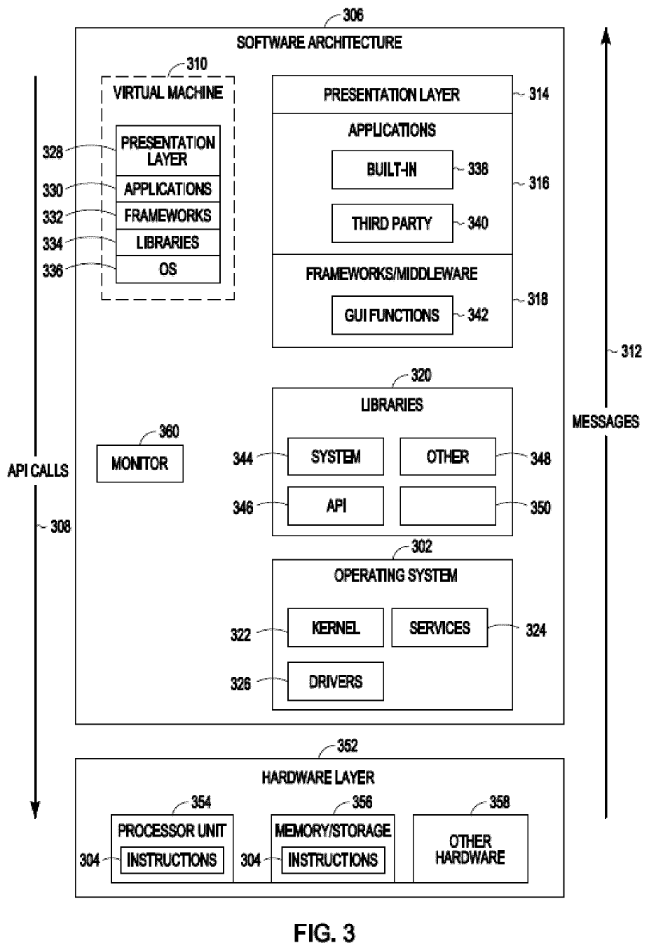

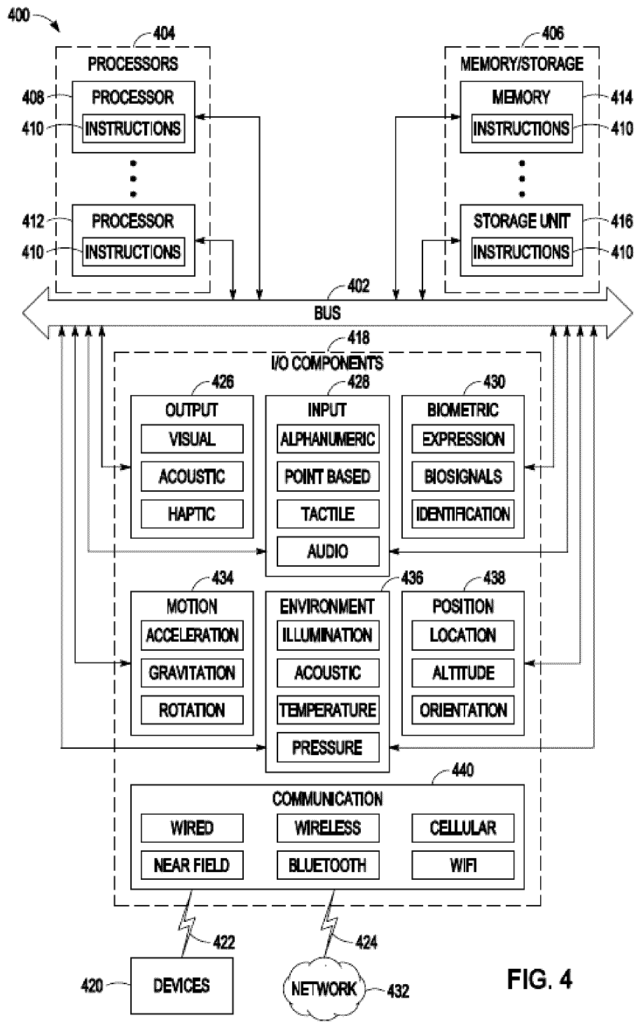

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

The image generator may invoke multiple generative systems to produce images. For example, multiple language models (LMs) and text to image models may be used to generate images having specific target characteristics. The image generator may inference a first generative system (e.g., an LM) to determine natural language prompts having textual instructions to generate images (e.g., create an image of a cyclist riding a red bicycle). One or more tokens from a visual vocabulary (e.g., T*) may be included in the natural language prompts to guide the image creation of a second generative system (e.g., a text to image model) by ensuring the visual characteristics associated with the token(s) are included in the images produced by the generative system. For example, the natural language prompt: “create an image of a cyclist in the style of T* riding a red bicycle” may be used to create an image including a cyclist having the visual characteristics associated with the token, T*, riding a red bicycle. The image generator may also invoke an image evaluator that may review images created by the generative systems. The image evaluator may inference a performance model that may rank the generated images based on one or more criteria (e.g., a predicted likelihood that each image will have a high level of engagement and/or meet a predefined threshold for one or more engagement metrics). The image evaluator may then recommend images based on the ranking associated with each image.

The technology described herein increases the creativity and precision of image generation systems. The performance of generative systems including GAN models, stable diffusion models, and is limited because these systems are trained on general purpose training data. The novel training process performed by the image generator described herein overcomes these performance limitations by teaching generative systems a visual vocabulary over a series of specific training steps on highly targeted training datasets. During each training step only a small portion of the generative system is trained (e.g., one or more text embeddings of a custom token). Other portions of the generate system are locked so they cannot be modified during training. This highly targeted training process is required to give the generative system a textual understanding of the visual characteristics associated with each token in the visual vocabulary, without biasing (e.g., overfitting) generative system to only the images in the highly targeted training datasets. The targeted training process allows the generative system to generate a diverse range of images having one or more specific, desired visual characteristics that may be difficult to recognize and/or hard to accurately describe in natural language text. The textual understanding of the visual characteristics associated with each custom token in the visual library enables the generative systems Therefore, it may be impossible or take several prompt iterations to create a variety of images that extend beyond the general purpose training data, for example, by generating images that modify the traditional appearance of an object as shown in the general purpose training dataset to a particular style and/or unique appearance of the object in the highly targeted training dataset. By including one or more custom tokens of the visual vocabulary in natural language image generation prompts, the creation process of generative systems may be controlled more precisely, for example, by creating images having specific visual characteristics associated with each of the one or more custom tokens. The image generator may use the visual vocabulary to create images having one or more specific visual characteristics even if the visual characteristics are unrecognizable or difficult to describe in natural language text.

The image generator may also improve the speed and efficiency of text guided image generation processes. The increased precision of the image generator speeds up image generation by reducing the amount of time spent drafting targeted prompts and performing iterative prompt-completion cycles with a LM or other generative system currently required to generate images of a target subject having a desired style or aesthetic. The image generator may also improve the quality of generated images and the performance of content campaigns that include the generated images. The image generator may train generative systems to recognize visual characteristics of high performing images (e.g., images generating a desired click-through rate, or engagement metric) from a library of images included in previously completed content campaigns. The image evaluator may then review generated images produced using the custom tokens associated with the high performing visual characteristics to rank the images based on one or more performance criteria. The image generator may recommend the generated images having the highest probability of performing well to improve the performance of campaigns including the generated images. The image generator may improve the generative systems and image evaluator over time by updating these components based on feedback observed for previously generated images to continuously improve the quality of the generated images and performance of campaigns that include generated images.

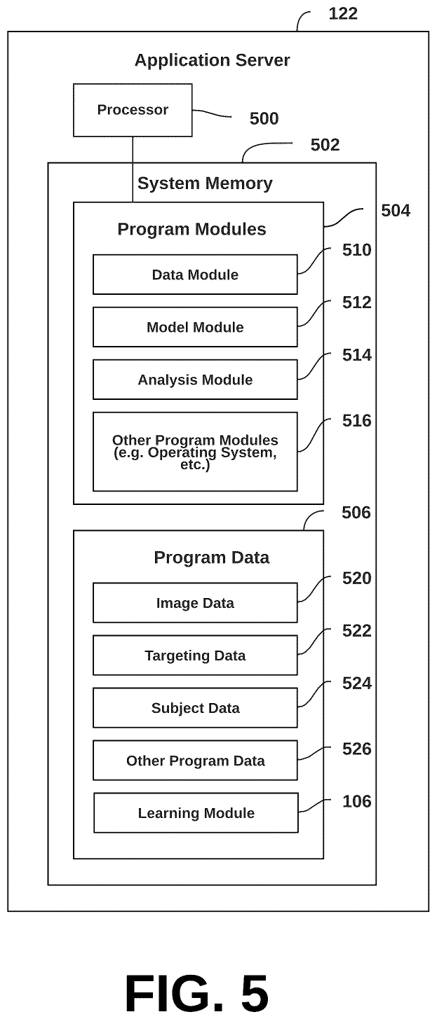

FIG. 5 illustrates an application server 122 hosting a learning module. The application server 122 may include at least one processor 500 coupled to a system memory 502 that may include computer program modules 504 and program data 506. In various embodiments, program modules 504 may include a data module 510, a model module 512, an analysis module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the learning module. Additionally, although shown as a single application server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include image data 520, targeting data 522, subject data 524, and other program data 526 such as data input(s), third-party data, and/or others. Program data 506 may also include instructions, data, and other resources used to implement the learning module described further below.

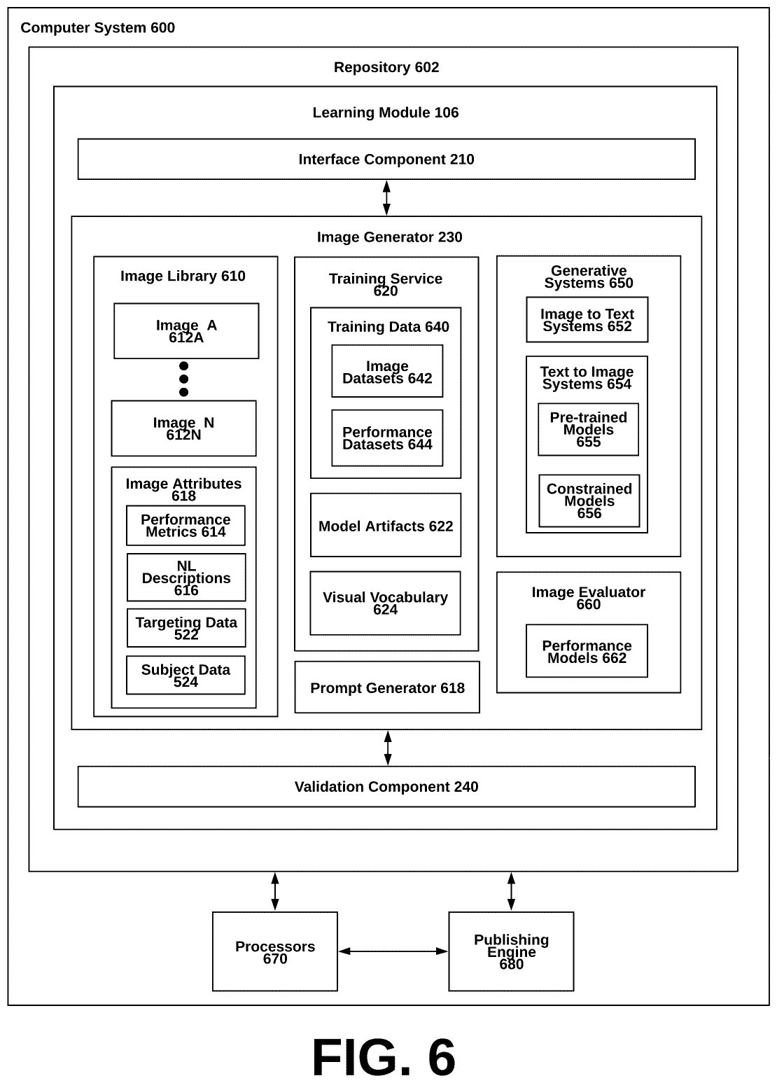

FIG. 6 is a block diagram illustrating more details of the learning module 106 in accordance with one or more embodiments of the disclosure. The learning module 106 may be implemented using a computer system 600. In various embodiments, the computer system 600 may include a repository 602, a publishing engine 680, and one or more computer processors 670. In one or more embodiments, the computer system 600 takes the form of the application server 122 described above in FIG. 1 or takes the form of any other computer device including a processor and memory. In one or more embodiments, the computer processor(s) 670 takes the form of the processor 500 described in FIG. 5.

In one or more embodiments, the repository 602 may be any type of storage unit and/or device (e.g., a file system, database, collection of tables, or any other storage mechanism) for storing data. Further, the repository 602 may include multiple different storage units and/or devices. The multiple different storage units and/or devices may or may not be of the same type or located at the same physical site. The repository 602 may include a learning module 106 having an interface component 210, image generator 230, and a validation component 240.

At runtime, a publishing engine 680 (e.g., a publishing engine included in the publishing system 130 of FIG. 1) may provide an image request for image data to the learning module 106. The request may include subject data 524 that describes the subject matter of the image data to be generated and targeting data 522 that describes one or more attributes of a target audience for the generated image data. The image generator 230 may receive the image request and generate image data including one or more images having one or more targeted visual characteristics identified from the image request. The image generator 230 may include one or more generative systems 650 produce images based on the subject data 524 and/or targeting data 522 included in the image request. The generative systems 650 may include one or more image to text systems that determine one or more natural language prompts describing different variations of images of a particular subject matter (e.g.,. the product, object, scene, and the like) described in the subject data 524. The generative systems 650 may also include one or more text to image systems 654 that may generate one or more unique images of the subject matter based on the descriptions included in the prompts.

In various embodiments, the text to image systems 654 may be trained to generate images having specific visual characteristics associated with one or more custom tokens included in a visual vocabulary 624. The image generator 230 may also include one or more image evaluators 660 that may review the images generated by the generative systems 650. The image evaluators 660 may interference one or more performance models 662 that may rank the generated images based on one or more criteria. For example, the image evaluators 660 may rank the generated images based on a predicted likelihood the images, once published, will achieve a desired click through rate or one or more other performance metrics. The image evaluators 660 may recommend one or more generated images for publication based on the ranking. The image generator 230 may provide a selection of the top ranked generated images to the publishing engine 680 so that the generated images may be included in content published by the publishing system.

In various embodiments, the publishing engine 680 may incorporate image data (e.g., images, video, extended reality media, and the like) from the image generator 230 into one or more pieces of content including, for example, webpages, websites, emails, display ads, text messages, push notifications linear tv ads, segments of streaming video, video game components, virtual reality media, mixed reality media, augmented reality media, extended reality media, and the like. The publishing system may run one or more campaigns that publish the pieces of content from the publishing engine 680 so that the generated image data may be displayed on one or more devices. For example, the publishing system may send an email including one or more generated images and/or place generated image data in a placement within a webpage, website, segment of streaming video, video game world, piece of extended reality media, and the like. The publishing system may also send a text message, push notification, chatbot response, or other digital message including one or more generated images or other pieces of image data.

The interface component 210 may provide a conversational interface the receives targeting data 522, subject data 524, and other data from one or more client devices running an instance of the publishing system. The conversational interface (e.g., the conversational user interface) may receive data from one or more GUIs (e.g., campaign configuration GUIs) displayed on one or more client devices by the publishing system. The conversational interface may receive data in the form of natural language text input into-and or generated by the GUIs displayed by the publishing system so that users of the publishing system may use natural language prompts to generate images with the image generator 230. The conversational interface may also receive data from the publishing system based on one or more user selections, clicks, or other inputs into the GUIs displayed by the publishing system.

The interface component 210 may also assemble one or more training datasets used in the training process performed by the image generator 230. The interface component may assemble the training datasets by performing Extract, Transform, and Load (ETL) tasks. The ETL jobs may determine one or more image attributes 618 for images and use the image attributes 618 to retrieve specific sets of images 612A, . . . , 612N from the image library 610 to include in image datasets 642 used for training data 640. The image attributes 618 may include one or more pieces of targeting data 522 and/or subject data and/or one or more performance metrics 614. Subject data 524 may describe visual characteristics of the image data of each of the images 612A, . . . , 614N stored in the image database 610. Subject data 524 may include for example, natural language descriptions 616 of the subject matter captured in the image data, categories of subject matter captured in the image data, intended uses of the image data, brands and/or products associated with the image data, color palettes shown in the image data, one or more scenes or environments that form the background of one or more images included in the image data, size and/or resolution of the image data, types of customers likely to engage with content included in the image data, and the like. The natural language descriptions 616 may be generated by a generative system such as an LM or other image to text model (e.g., an LM that has been pre-trained using BLIP, BLIP-2, or other visual-language pre-training (VLP) process). Subject data 524 may be recorded by a publication system as one or more configuration settings for a campaign that publishes content including image data for one or more of the images 612A, . . . ,612N. The ETL jobs may associate the subject data 524 recorded for each campaign with the corresponding images 612A, . . . ,612N included in the campaign and store the associated subject data 524 as image attributes 618.

Targeting data 522 may describe audiences of users that are likely to engage with (e.g., view, click, comment on, transact, and the like) the generated images. Targeting data 522 may include, for example, brand and/or product propensity scores that provide a probability a consumer will purchase a particular product or transact with a particular brand, respectively. Targeting data 522 may also include brand and/or product affinity scores that provide a probability a consumer will engage with content from a particular brand and/or content associated with a particular product, respectively. Other pieces of targeting data 522 may include one or more subject matter codes (e.g., z codes) associated with articles and other online content items. The subject matter codes may include classifications for the subject matter of the content (e.g., finance, business, entertainment, sports, and the like) and/or personality traits for consumers that may be interested in the content (e.g., intelligent, funny, entrepreneurial, adventurous and the like). Targeting data 522 may be recorded by a publication system as one or more configuration settings for campaigns publishing content including image data. The ETL jobs may associate the targeting data 522 recorded for each campaign with the corresponding images 612A, . . . ,612N included in the campaign and store the associated targeting data 522 as image attributes 618.

The performance metrics 614 may include, for example, impressions, clicks, view rate, click through rate, conversion rate, and the like) determined for one or more campaigns publishing content including the image data for one or more images 612A, . . . ,612N. The performance metrics 614 for each of the images 612A, . . . ,612N in the image library 610 may be retrieved from the publication system running the campaigns including the image data. The publication system may track actions (e.g., deliveries, displays, impressions, views, clicks, purchases, conversions, and the like) observed for each piece of content including the images 612A, . . . , 612N and determine one or more performance metrics based on the observed actions. For example, the publication system may determine a click through rate for an image 612A by calculating the ratio of the number of clicks observed for content including the image 612A by the number of displays observed for the same content. The ETL jobs may associate the performance metrics 614 determined for each campaign with the corresponding images 612A, . . . , 612N included in the campaign and store the associated performance metrics 614 as image attributes 618.

The performance metrics 614 for each of the images 612A, . . . , 612N may be determined for all campaigns including a particular image 612A and/or on a campaign by campaign basis so that multiple image attributes may be used to select images 612A, . . . ,612N for image datasets 642. For example, one or more performance metrics 614 and pieces of targeting data 524 may be used to select images 612A, . . . ,612N that perform well for specific segments. In another example, one or more pieces of targeting data 522 and subject data 524 may be used to select images 612A, . . . ,612N of a particular object that are included in campaigns targeting specific audience segments. performance metrics observed for specific audience segments may be used as a criteria for selecting images 612A, . . . ,612N for image datasets 642.

The ETL jobs may index the images 612A, . . . , 612N in the image library 610 by the image attributes 618 so that different combinations of images attributes may be used to select multiple images 612A, . . . ,612N for image datasets 642 that have one or more characteristics. For example, the extracted images may have one or more common subjects, be associated with a particular brand or product, and/or have performance metrics 614 that meet one or more performance thresholds.

The interface component 210 may also receive targeting data 522 and subject data 524 in the form of a natural language description of a target audience and image subject matter, respectively, from a client application running an instance of the publishing system on a client device. For example, the conversation interface provided by the interface component 210 may receive the natural language descriptions of the user attributes to include in the targeting data 522 and the image attributes to include in the subject data 524.

The interface component 210 may also retrieve new images included in recently run campaigns new and/or updated image attributes 618 after one or more campaigns including generated images have been run by the publishing system. The image attributes 618 for the new images may include engagement rates and other performance metrics 614 for one or pieces of content including image data generated by the image generator 230. A DSP, ESP, or other publishing system may determine the performance metrics by tracking clicks, views, conversions, and other event data capturing actions associated with pieces of content that include generated images. The engagement rates for each campaign and other performance metrics 614 may be stored as new image attributes for the new and/or existing images 612A, . . . ,612N included in the campaigns. The ETL jobs may select one or more new images for one or more images datasets 642 and/or use the new image attributes as an updated image selection criterion. The training service 620 may use the image datasets 642 including the new images and/or selected using the new image attributes to re-train the model to determine new custom tokens and/or optimize the text embeddings of existing custom tokens to improve the quality of the generated images. Retraining the generative systems 650 using image datasets 642 including new images and/or selected using the new image attributes may continuously improve the quality and performance of the images generated by the image generator 230. The retaining process may also increase one or more confidence metrics of the generative systems 650 by introducing new custom tokens that may align more closely with target visual characteristics. The retraining process may also increase the specificity of the generated images by training new custom tokens and/or optimized custom tokens that may be unique relative to the existing custom tokens in the visual library and may thereby create a further differentiated the visual library that can create images embodying more specific target visual characteristics.

The image attributes 618 determined by the interface component 210 may be linked to the images 612A, . . . ,612N included in the image library 610. The training service 620 may access the image library 610 select specific sets of images 612A, . . . ,612N to include in image datasets 642. The training service 620 may use the image datasets 642 as training data 640 used to train the generative systems 650 to develop a textual understanding of one or more visual characteristics. In various embodiments, the training service 620 may use the image attributes 618 to select image data for a sample of images 612A, . . . ,612N that have one or more visual characteristics. The training service 620 may use the selected image data to perform a training process that trains one or more components of the text to image systems 654 to develop a textual understanding of the one or more visual characteristics included in the set of images 612A, . . . ,612N. Different combinations of image attributes (e.g., pieces of targeting data 522 and/or subject data 524 and/or NL descriptions 616 and/or performance metrics 614) may be used to select the images 612A, . . . ,612N having specific visual characteristics. For example, the training service may filter the images 612A, . . . ,612N using subject data, targeting data 522, and performance metrics 614 to select an image dataset 642 including high performing images of a particular subject (e.g., a dog) used to market a particular product and/or brand (e.g., dog food) to a particular audience (e.g., homeowners between 35 and 45 that lives in a particular location (e.g., Tennessee). The training service 650 may determine image datasets by selecting one or more images 612A, . . . ,612N that achieve a threshold level of performance (e.g., meet or exceed a minimum click through rate threshold, e.g., 0.15) and meet one or more other desired selection criteria including, for example, a specific natural language description and/or piece of targeting data 522 and/or subject data 524. If multiple images are selected, the training service 650 may refine the set of select images to a limited number (e.g., 3-5 images) by selecting images having the highest values for one or more performance metrics and removing the images with lower values from the selection.

To select images 612A, . . . ,612N having one or more user selected target visual characteristics, the training service 650 may identity one or more image attributes 618 included in an image request. The training service 650 may filter the images 612A, . . . ,612N in the image library 610 using the identified image attributes 618 to select the images 612A, . . . ,612N having the desired attributes. The selected images may be used to train a custom token that may be used to generate images having the user selected target visual characteristics. In various embodiments, the training service 620 may determine image datasets 642 dynamically in response to image requests. The training service 620 may assemble unique image datasets 642 for each image attribute included in an image request and train the generative systems 650 develop an understanding of the user selected visual characteristics included in each image request. For example, the training service 650 may assemble an image dataset 642 of high performing images of dogs and other objects included in subject data 524 and/or an image dataset 642 of high performing images targeting homeowners, and high performing images targeting adults ages 35-45, and other user characteristics included in targeting data 522. Each of the unique image datasets 642 may be used to train a different custom token. The unique custom tokens may be stored in a visual vocabulary 624 that may be used by the generative systems 650 to generate images that are specific to the image request. The images generated using the visual vocabulary 624 may also have multiple unique sets of visual characteristics learned from image datasets having different image attributes. Including custom tokens for multiple visual characteristics in image generation prompts may enhance the specificity, quality, and performance of the generated images.

The generative systems 650 may be trained to generate images having target visual characteristics using multiple training processes. In various embodiments, the training service 620 may perform a pre-training process to train the image to text system 654 (e.g., GAN, diffusion model, stable diffusion model, or other LM trained to generate images from text descriptions) on a general purpose image dataset. The general purpose image dataset may include a large number (e.g., millions, billions, or more) of images having a wide range of subject matter. For example, the general purpose image dataset may include all of the images in the image library 610 (e.g., all of the images included in content used in campaigns run on one or more publishing systems). The general purpose image dataset may also include other datasets including large numbers of images scraped from the Internet. The pre-training process may train one or more pre-trained models 655 of the image to text system 654. The training service 620 may further train the pre-trained models 655 using a selective training process that may fine-tune the pre-trained models 655 by teaching the models a textual understanding of one or more visual characteristics depicted in specific samples of images included in one or more targeted image datasets. During the fine-tuning process, the constrained models 656 may learn a text embedding for a custom token that represents the textual understanding of the visual characteristics depicted in the targeted images. One or more custom tokens may be included in image generation prompts submitted to the constrained models 656 in order to generate images including target visual characteristics.

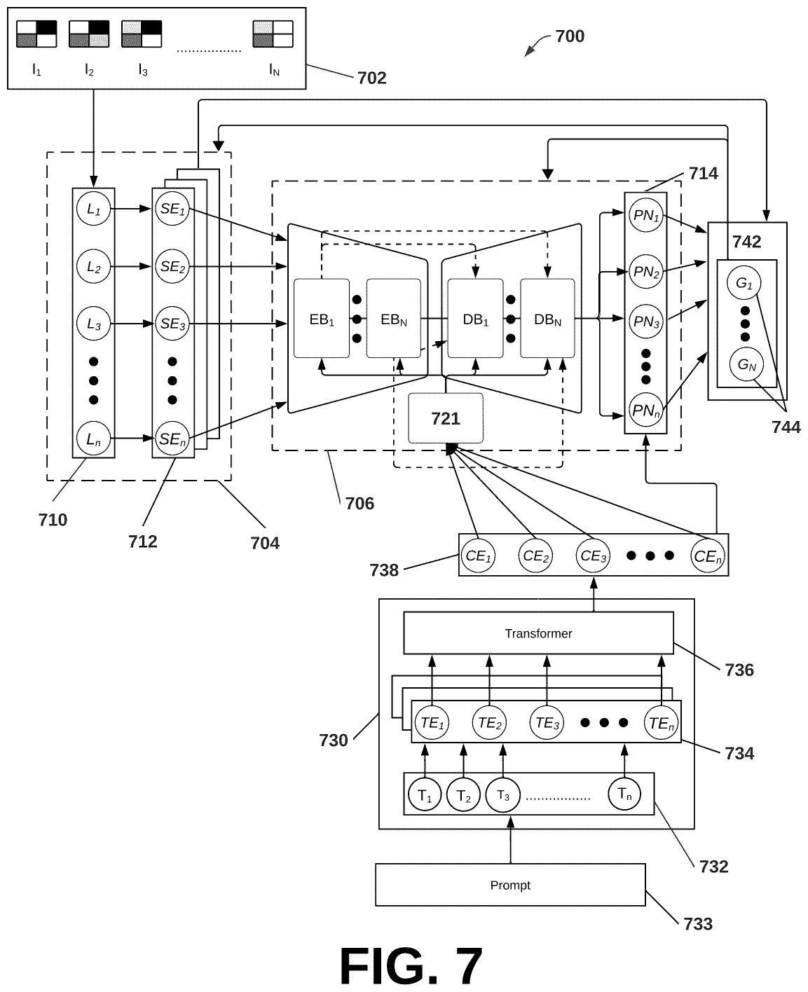

FIG. 7 illustrates an example pre-training process for one example of a pre-trained model, a stable diffusion model 700. The pre-trained stable diffusion model 700 may include an encoder 704 having one or more compression layers 710 and one or more diffusion layers 712. The compression layers 710 may compresses the images in the training sample 702 to lower resolution representations of the image data called latents (e.g., L₁, . . . ,L_{N}). For example, compression layers may compress images that are 512 pixels by 512 pixels into a latent that is 64 pixels by 64 pixels. The diffusion layers 712 may perform a forward diffusion process that adds noise to the latents on top of the original compressed image data. The forward diffusion process may gradually add noise to the latents over a period of time (e.g., more noise is added at each time step in the period) until the data in the latent is indistinguishable from random noise. In each training epoch, a time step in the forward diffusion process is selected randomly for each latent. The diffusion layers apply an amount of gaussian noise to each latent that corresponds to the selected time step to create a set of noisy latents. The time steps for the noisy latents are converted to vectors (e.g., step embeddings) that are optimized during the training process.

During each training step, the step embeddings and noisy latents generated by the encoder 704 are fed into the denoising network 706. One or more conditional vectors (e.g., text embeddings) may also be fed into the denoising network 706. The text embeddings for each latent may be determined by a transformer model 730 (e.g., an LM, text generation model, image to text model, and the like) based on a prompt 733 including one or more natural language descriptions of the original image data compressed in each latent. For example, the text embeddings for a latent including a compressed image of a dog walking on a leash may be determined by mapping each word in the phrase “an image of a dog on a leash” to a learned text embedding space. The transformer model 730 may determine the text embeddings for each latent using a tokenizer 732 that converts each word in a prompt into a token (T₁, . . . ,T_{N}) and one or more hidden layers 734 that map the tokens to the learned text embedding space. The hidden layers 734 may determine one or more text embeddings (TE₁, . . . , TE_{N}) for each token based on the position of the token vector within the model's text embedding space. The text embeddings (TE₁, . . . , TE_{N}) represent the understanding of the transformer model of the words in the prompt and the model's text embedding space represents the model's understanding of language achieved during pre-training on a vast corpus of text (e.g., a library including billions or more articles, documents, books, and other or other pieces of text).

A transformer 736 may map the text embeddings (TE₁, . . . , TE_{N}) determined for each prompt 733 to conditional embeddings (CE₁, . . . ,CE_{N}) that correspond to a position within a latent space determined by the denoising network 706. The conditional vector embeddings (CE₁, . . . ,CE_{N}) may be concatenated in a condition vector 738 that may be combined with one or more other conditional vectors (e.g., semantic maps, images, inpainting, and other spatially aligned inputs). The conditional vectors 738 for each latent may be mapped into the denoising network using a cross attention block 721 that maps the text embeddings via a multi-head attention layer and concatenates the special aligned inputs with the input noisy latent.

The denoising network 706 predicts the noise in each of the noisy latents using one or more encoder blocks (EB₁, . . . ,EB_{N}) that compress the image data included in the noisy latents into a lower resolution image representation and one or more decoder blocks (DB₁, . . . ,DB_{N}) that decode the lower resolution image representation back to the original higher resolution image representation. The output layer 714 of the denoising network 706 may determine the predicted noise (PN₁, . . . ,PN_{N}) for each of the input noisy latent based on the output of the decoder blocks (DB₁, . . . ,DB_{N}). The predicted noise (PN₁, . . . ,PN_{N}) determined by the denoising network 706 is compared to the true noise at the time step of the noisy latents determined by the diffusion layers 712. The predicted noise and true noise may be compared using a loss function 742 that calculates a loss value that measures the difference between the predicted noise and true noise. The loss value may be used to determine a gradient 744 that can be used to backpropagate the loss through the network to improve the performance of the model 700 by optimizing the weights of the denoising network 706 and the weights of the transformer 736 used to determine the conditional vector 738. The loss may be backpropagated by modifying weights of the denoising network 706 and/or embeddings of the transformer 736 based on the gradient 744, for example, by adding the gradient 744 to each weight and/or embedding to adjust the weights and/or embeddings in the direction of the loss.

Through the pre-training process, the denoising network 706 may learn the amount of noise applied by the forward diffusion process at each time step and the transformer network 730 may learn to map conditional embeddings to the latent space so that the pre-trained model 700 may generate images in response to text prompts by iteratively removing noise from a latent of random noise to determine a latent having a position within the latent space that corresponds to the conditional vector.

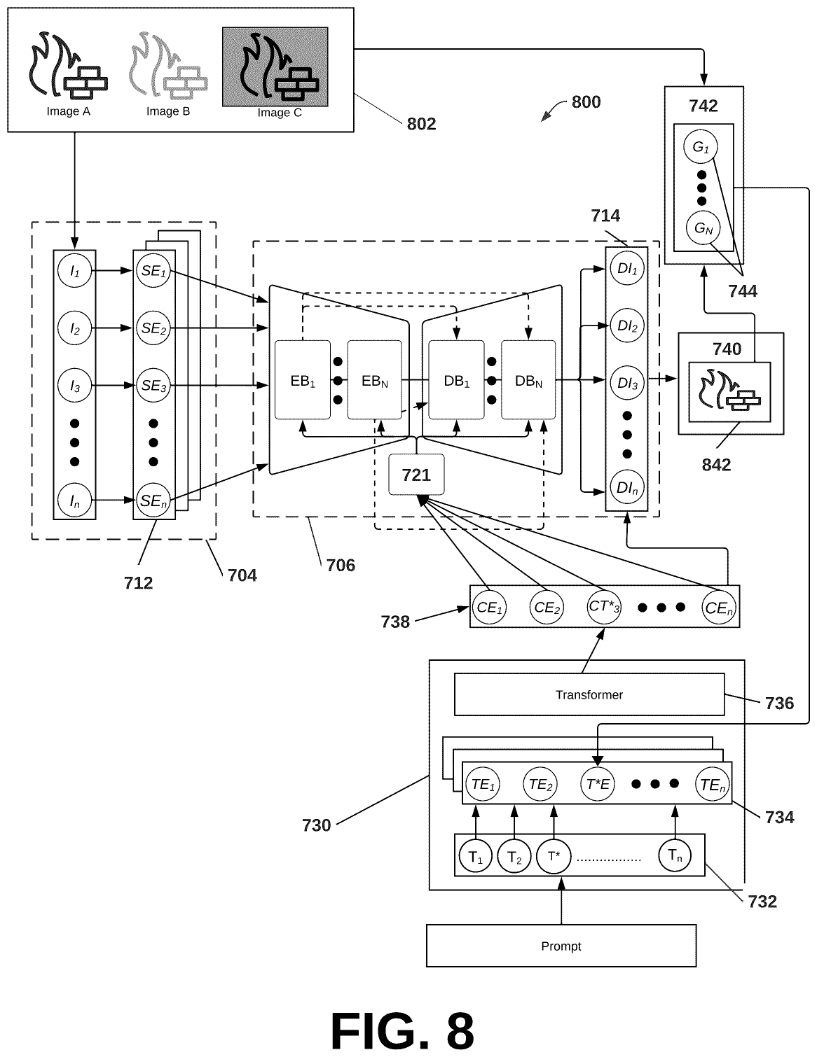

FIG. 8 illustrates a selective training process for training the generative systems to develop of textual understanding of targeted visual characteristics. The selective training process may use a small (e.g., 3-5), specific set of images included in a targeted image sample 802 (e.g., a targeted image dataset) to fine-tune the pre-trained models by teaching the models a textual understanding of one or more visual characteristics depicted in the images of the fine-tuning dataset. FIG. 8 illustrates an example selective training process for one example of a constrained model, a constrained stable diffusion model 800. To train the model, a targeted image sample 802 of images may be selected. The images included in the targeted image sample 802 may include different variations of the same visual characteristics. For example, the targeted images may show different variations of the same or similar objects (e.g., images of the same object in different styles, aesthetics, settings, roles, poses, and the like). The images in the targeted image sample may also show a range of multiple different objects having a shared style, aesthetic, setting, role, pose, or other visual characteristics.

In various embodiments, one or more image attributes may be used to select images for a targeted image sample 802. For example, a performance based selection process may use one or more performance metrics measured over one or more completed campaigns to select images. The performance metrics may include click through rate, open rate, conversion rate, and the like and images may be selected for the targeted image sample 802 based on a maximum value and/or threshold value for one or more of the performance metrics. The performance based selection process may identify images having unrecognizable visual characteristics that enable them to achieve high levels of engagement or otherwise perform well.

To make the performance based selection process more targeted, other image attributes may be used to select images for fine tuning samples 802. In various embodiments, targeted images may be selected using subject data to select images having a particular subject matter. Targeting data may also be used to select targeted images to enable images to be chosen based on the attributes of audience segments associated with the image. One or more subject data and/or targeting data selection criteria may be combined with one or more performance selection criteria to assemble more specific targeted image samples 802. For example, a sample of images of a certain product or object that have the highest click through rates (e.g., the image having the maximum value for click through rate and the 4 or some other predetermined number of images having click through rate values that are closest to the maximum click through rate value) may be selected for a targeted image sample 802. In another example, a predetermined number of images having adults 35-45 as a targeting data attribute and that meet or exceed a conversion rate threshold (e.g., 3%) over at least one campaign running for a period of time (e.g., at least 2 days) may be selected for a targeted image sample 802. The selected images may be modified and/or filtered to limit the targeted image sample 802 to a predetermined number of images (e.g., three to five images) that include a common set of visual characteristics.

To train the constrained models 800, an image (I₁, . . . ,I_{N}) from the fine tuning sample 802 is fed into the encoder 704 of the pre-trained stable diffusion model during each training step. The diffusion layers 712 perform a forward diffusion process that iteratively adds noise to the images at multiple time steps during a time period until the added noise fully masks the image data so that the image is indistinguishable from random noise. Each of the time steps may be encoded by the diffusion layers 712 as a step embedding (SE₁, . . . ,SE_{N}) that corresponds to a noisy image generated at the particular time step. The step embeddings and noisy images are fed into the denoising network 706 that attempts to reconstruct the original image using one or more encoder blocks (EB₁, . . . ,EB_{N}) that compress the image data included in the noisy images into a lower resolution image representation and one or more decoder blocks (DB₁, . . . ,DB_{N}) that decode the lower resolution image representation back to the original higher resolution image representation.

The denoising network 706 may be conditioned by the transformer model 730. To train the constrained stable diffusion model 800 to develop an understanding of visual characteristics, a set of neutral prompts for each image is fed into the transformer model 730. The prompts may each include a custom token (T*) that represents the visual characteristics to be learned during the selective training process. The neural prompts may include image generation commands with a neural context, for example, “a photo of T*”, “an image of T*”, a rendition of T*” and the like. A tokenizer 732 tokenizes the prompts to generate a string of tokens that are mapped to the transformer model's 730 learned text embedding space by the hidden layers 734. To perform the mapping, the hidden layers 734 may determine text embeddings for each token (T₁, . . . ,T_{N}) in the prompt. Custom token (T*) is a pseudo word that does not appear in the transformer model's 730 training data therefore the text embedding for the custom token (T*E) is initialized to a random value that is optimized during the selective training process. A transformer layer 736 maps the text embeddings (TE₁, . . . , TE_{N}) to conditional embeddings (CE₁, . . . ,CE₂) that are included in a conditional vector 738 that is fed into the denoising network 706. An attention layer implemented using a cross attention block 721 may be used to map the conditional embeddings to the encoder blocks (EB₁, . . . ,EB_{N}) and decoder blocks (DB₁, . . . ,DB_{N}) of the denoising network 706.

During each training step of the selective training process, the denoising network 706 receives a step embedding, noisy image, and a conditional vector 738 and attempts to reconstruct the image from the fine tuning sample 802 that corresponds to the noisy image. A different time step may be used for each training step so that, in each training epoch, the denoising network 706 may attempt to reconstruct each image in the fine tuning sample 802 using the noisy images and step embeddings generated at every time step in the forward diffusion process. A decoder 740 generates the reconstructed image based on the denoised image representation (DI₁, . . . ,DI_{N}) determined by the output layer 714 of the denoising network 706.

The reconstructed image 842 determined by the denoising network at each time step may be compared to the original image in the targeted image sample 802. The reconstructed image 842 and the original image may be compared using a loss function 742 that calculates a loss value that measures the difference between the reconstructed image and the original image. The loss value may be used to determine a gradient 744 that can backpropagate the loss through the network to improve the performance of the constrained stable diffusion model 800.

In the selective training process, only the text embeddings of the custom token (T*E) (e.g., the custom token embedding) are trained. The model components and/or model artifacts that are not used to determine the text embedding for the custom token are frozen. For example, embeddings for the other tokens in the prompt, the conditional embeddings output by the transformer 736, and the weights of the denoising network 706 and the encoder 704 are all frozen and kept constant during training. To determine the text embeddings for the custom token (T*E) the loss measured for each image reconstruction task is back propagated through the portion of the transformer model 730 related to the custom token embedding. The loss determined by the loss function, may be backpropagated through the hidden layers 734 by modifying custom token embedding (T*E) based on the gradient 744, for example, by adding the gradient 744 to the custom token embedding to adjust the embedding in the direction of the loss. The value of the text embedding for the custom token (T*E) may be optimized over multiple image reconstruction tasks and an new error value may be determined after each task. The error value determined for each task may be compared to an error threshold and the selective training process may be completed once the error value does not exceeds the error threshold.

During the selective training process, only the text embedding for the custom token (T*E) is trained during the image reconstruction tasks so that the custom token embedding may learn the visual characteristics of the images in the targeted image sample 802. To develop a textual understanding of the visual characteristics, the custom text embedding for the custom token is mapped to the text embedding space of the transformer model 730. The mapping of the custom text embedding is optimized during the selective training process so that the trained custom text embedding forms a textual representation of the visual characteristics of the images in the fine tuning sample 802. After the selective training process is completed for one custom token, the constrained model 800 may be deployed to production. The constrained model 800 may also be re-trained by repeating the selective training process using a new targeted image sample 802 to train a new custom token to develop a textual understanding of the visual characteristics of images include in the new targeted image sample 802. The selective training process may be repeated multiple times with different images selected for the fine tuning sample to train multiple custom text embeddings for multiple custom tokens with each custom text embeddings storing a textual representation of unique visual characteristics. The custom tokens associated with each trained custom embedding may form a visual library that may store a textual understanding of multiple visual characteristics. One or more of the custom tokens in the visual library may be included in natural language image generation prompts to generate images having the target visual characteristics mapped to the custom tokens included in the prompts.

Referring back to FIG. 6, at runtime, the interface component 210 may receive an image request from, for example, a client device running a client application connected to the publication system. The image request may specify one or more characteristics of desired images to be generated by the image generator 230. For example, the image request may include a natural language description of the targeting data 522, subject data 524, and/or performance metrics 614 for a set of desired images. The characteristics of desired images may also include one or more selections of performance metrics 614 and/or pieces of targeting data 522 and/or subject data 524 of desired images determined based on user inputs into a configuration interface or other GUI displayed on a client device by the publication system.

The image generator 230 may generate images that have one or more target visual characteristics that align with the characteristics of desired images specified in the image request. To align the target visual characteristics of generated images with the characteristics specified in the image request, the image generator 230 may determine a custom set of seed images and a selection of custom tokens that are used to generate the image generation prompts for the requested images. The interface component may determine a custom set of seed images by parsing the natural language descriptions and/or user selections to identify one or more performance metrics 614 and/or natural language descriptions of images 616 and/or pieces of targeting data 522 and/or pieces of subject data 524 or other characteristics of desired images included in the image request. The identified characteristics may be stored as seed data. The interface component 210 may filter image data included an image library 610 using one or more pieces of seed data to identity a custom seed dataset including a set of images 612A, . . . ,612N that are specific to the characteristics in the image request. For example, the interface component 210 may map one or more pieces of seed data to one or more corresponding image attributes and retrieve the images using the mapped image attributes. The identified images 612A, . . . , 612N included in the seed dataset may be fed into an image to text system 652 (e.g., a BLIP, BLIP-2, of other LM trained to understand images and text) to generate seeds for each of the identified images 612A, . . . ,612N. The seeds may be natural language descriptions of the subject matter shown in each of the identified images.

The prompt generator 618 may determine one or more image generation prompts for generating images using the seeds and seed data. The prompt generator 618 may include multiple LMs trained to perform specific actions that produce the image generation prompts. The multiple LMs may be trained to include one or more custom tokens aligned with the characteristics of desired images in the image generation prompts. The multiple LMs may include a seed LM and a prompt LM. The seed LM may determine seed prompts based on the seeds and seed data and the prompt LM may determine image generation prompts for a text to image system 654 based on the seed prompts. The seed LM may determine a seed prompt based on a given set of seeds and seed data and one or more example seed prompts. The seed LM may assemble the seeds and/or seed data into one or more lines of natural language text that resemble the content and format of the example seed prompts. The one or more lines of natural language text may instruct the prompt LM to create a number of image generation prompts for a particular subject matter described in the seed data. The seed prompt may also include one or more example image generation prompts. The example image generation prompts may include one or more custom tokens of a visual vocabulary that are associated with one or more pieces of seed data or otherwise aligned with the characteristics or desired images included in the image request. One or more custom tokens that are associated with seed data may also be provided to the seed LM directly and included in seed prompts for the prompt LM.

To determine the custom tokens to include the seed prompts, the image generator 230 may determine one or more token attributes for each custom token. The token attributes may correspond to the image attributes (e.g., performance metrics 614 and/or pieces of targeting data 522 and/or subject data 524) of the images included in the targeted image dataset used to train the text embedding for each custom token. The image generator 230 may assemble an attributes database that includes each of the custom tokens in the visual vocabulary 624 and the token attributes associated with each custom token. The attributes database may be indexed by the token attributes and the attributes database may be proved to the seed LM so that the custom tokens having each token attribute may be determined quickly by the prompt generator 618. To determine the custom tokens to include in the seed prompts, the seed LM may map one or more pieces of seed data to one or more corresponding image attributes. The seed LM may identify the custom tokens having one or more token attributes that match one or more image attributes determined from the seed data. The seed LM may also identify one or more image attributes in the seeds generated by the image to text system. The seed LM may use the identified image attributes to retrieve one or more custom tokens having token attributes that match one or more of the image attributes included in the seeds. The seed LM may include the identified custom tokens in a seed prompt and/or draft one or more example image generation prompts that include one or more of the custom tokens.

In one example, the seed LM may generate a seed prompt for an image request that includes a dog and a dog treat product as subject data 524, adults aged 35-45 as targeting data 522, and a maximum click through rate as a performance metric 614. The seed prompt may include one or more lines of natural language text instructing a text to image system 654 to generate a number of image generation prompts (e.g., 3) for a dog and a dog treat product given a number of example prompts (e.g., “generate three image generation prompts for a dog treat product given example prompts: Example 1, Example 2, and Example 3”). The seed LM may determine one or more custom tokens to include in the example prompts by matching one or more pieces of seed data to the token attributes for at least one custom token. The seed LM may use the custom tokens associated with the matched attributes to draft a custom example prompt. For example, if D*, A*, PD* are custom tokens associated with the token attributes dogs, adults 35-45, and high clickthrough rate for dog product campaigns, respectively, the seed LM may determine an custom example prompt for the dog image request may be “generate an image an image of a dog eating a dog treat in the style of D*. The image should be adapted for targeting based on A*. The image should have a performance that achieves PD* when published.”.

The prompt LM may use the custom example prompts included in the seed prompt to generate image generation prompts that include one or more custom tokens. The prompt LM may also generate image generation prompts that include custom tokens that are listed in the seed prompts. Including the custom tokens in the image generation prompts enables the image generator 230 to produce images having target visual characteristics that align with the characteristics of desired images included in the image request. The seed LM determines the custom tokens having token attributes that match the image characteristics specified in the image request and the prompt LM determines images generation products that generate images having the visual characteristics embodied in the custom tokens. In various embodiments, the prompt LM may generate multiple image generation prompts for each image request to enable the image generator 230 to produce a range of multiple different images that may be further evaluated by the image evaluator before a final set of recommended images is provided to the user. The multiple image generation prompts may each include one or more unique custom tokens. The prompt LM may also create image generation prompts that include no custom tokens and/or multiple custom tokens.

In various embodiments, users may select target visual characteristics to include in generated images. For example, a publication system may include a configuration interface that display a key, table, or other UI component that lists the custom tokens included in the visual library and one or more token attributes associated with each of the custom tokens. Users may select, in the configuration interface, one or more custom tokens to use during image generation so that images generated by the image generator 230 may include the targeted visual characteristics associated with each of the selected custom tokens. The selected custom tokens may be included in the seed prompt from the seed LM to that the prompt LM may include the selected custom tokens in one or more of the image generation prompts created for the image request. Providing the user selected custom tokens to the prompt LM enables the image generator to create images that include target visual characteristics specified by users of the publication system.

The image generation prompts determined by the prompt LM are provided to the text to image systems 654. A constrained model 656 trained to understand the custom tokens included in the image generation prompts may be used to generate one or more images for each image generation prompt. The generated images may be transmitted to an image evaluator 660 that may review the generated images and recommend one or more images based on a predicted performance. The recommend images may be returned to the user and/or provided to the publishing engine 680 to include in one or more pieces of content.

The image evaluator 660 may include one or more performance models 662 that are trained by the training service 620. The performance model may include convolutional neural networks and other deep learning models. In various embodiments, the performance models 662 may be trained on image data included in the image library 610. For example, the performance models 662 may be trained on image datasets that comprise images included in one or more content campaigns previously run on the publishing system. The image data included in the image library 610 may be linked to one or more performance metrics 614 observed for the images during the duration of the campaign. The performance metrics 614 may describe a likelihood a user will perform an action that engages with the images and/or pieces of content including the images. The performance metrics 614 may include display rate, click through rate, impression rate, conversation rate, and the like. To determine the performance metrics 614, the publishing system may determine a total number of clicks or other engagement action performed by users that were served one or more of the images included in a content campaign. The publishing system may divide the total number of clicks or other action by the total number of times an image was served to determine the click through rate or other performance metric 614.

To train the performance models 662, the training service 620 may assemble training data 640 including one or more performance datasets 644. The performance datasets 644 may include image data for a selection of images and observed labels for each images that specify the click through rate of other performance metric measured for the image over one or more completed content campaigns. The performance datasets 644 may include image data for a wide variety of images including images having a range of different image attributes so that the performance model 662 may be trained to accurately predict the performance of images independent of the objects shown in the image or target audience for the image. During each training epoch, the image pixels for each image may be input into the performance model 662, The convolutional layers of the model may extract image features from the pixel data that are relevant to the performance of the image. The performance model 662 may generate a predicted label based on the extracted image features. The predicted label may include a predicted value for click through rate or one or more other performance metrics. The predicted labels and observed labels for each image may be compared using an error function that calculates an error value that measures the difference between the predicted labels and the observed labels. The training service 620 may run multiple training epochs to determine a stable error value for the performance model 662.

To optimize the performance model 662, the training service may use a gradient function to determine a gradient based on the error values. The weights of the convolutional layers may be adjusted based on the gradient (e.g., adjusted in the direction of the loss by adding the gradient to the values for each weight) and the adjusted weights may be included in an updated version of the performance model 662. In additional training steps, the updated performance model 662 may determine predicted labels using the adjusted weights. The values of the predicted labels determined by the updated model may change because the adjusted weights cause the convolutional layers to identity new image features in the images data and/or focus more and/or less attention on one or more previously identified features. The steps of training and optimizing the model described above may be repeated to re-train the performance model 662 until a desired level of prediction accuracy is achieved. For example, the performance model 662 may be re-trained until the error value calculated for the predicted labels is within a predetermined error threshold. Performance models 662 achieving a desired level of accuracy may be deployed to the image evaluator for interference. The trained weights of the performance models 662 achieving a desired level of accuracy may be stored as model artifacts 622.

At runtime, each of the images generated by text to image systems 654 may be transmitted to the image evaluator 660. The image pixels for each of the generated images may be input into trained performance model 662 to determine a predicted performance (e.g., predicted click through rate) for each of the generated images. The convolutional layers of the trained performance model 662 may identify features of the generated images that are relevant to the click through rate or other performance metric for the generated images. The trained performance model 662 may generate a predicted label for each of the generated images based on the identified image features. The trained performance model 662 may also rank each of the generated images based on the value for the predicted label. For example, the trained performance model 662 may determine a predicted label for each generated image including a predicted click through rate for the image. Each of the generated images may then be ranked based on the predicted click through rate with the image having the highest predicted click through rate value appearing first in the ranking and the image having the lowest predicted click through rate values appearing last in the ranking. The image evaluator 660 may recommend a predetermined number of generated images based on the ranking. For example, the image evaluator 660 may recommend the three highest ranked images. The recommended images may be transmitted to a publishing system configured to display the recommended images to a user in a configuration interface or other GUI displayed on a client device.

The recommended images may also be transmitted to the publishing engine 680. The publishing engine 680 may receive the recommended images and generate one or more pieces of content that include the recommended images. The generated pieces of content may be included in one or more content campaigns run by the publishing system. For example, the publishing engine 680 may assemble an email message or display advertisement including one or more of the recommended images and an ESP and/or DSP may publish the email message and/or display advertisement, respectively, to one or more specified locations or domains on a publication network (e.g., the Internet).

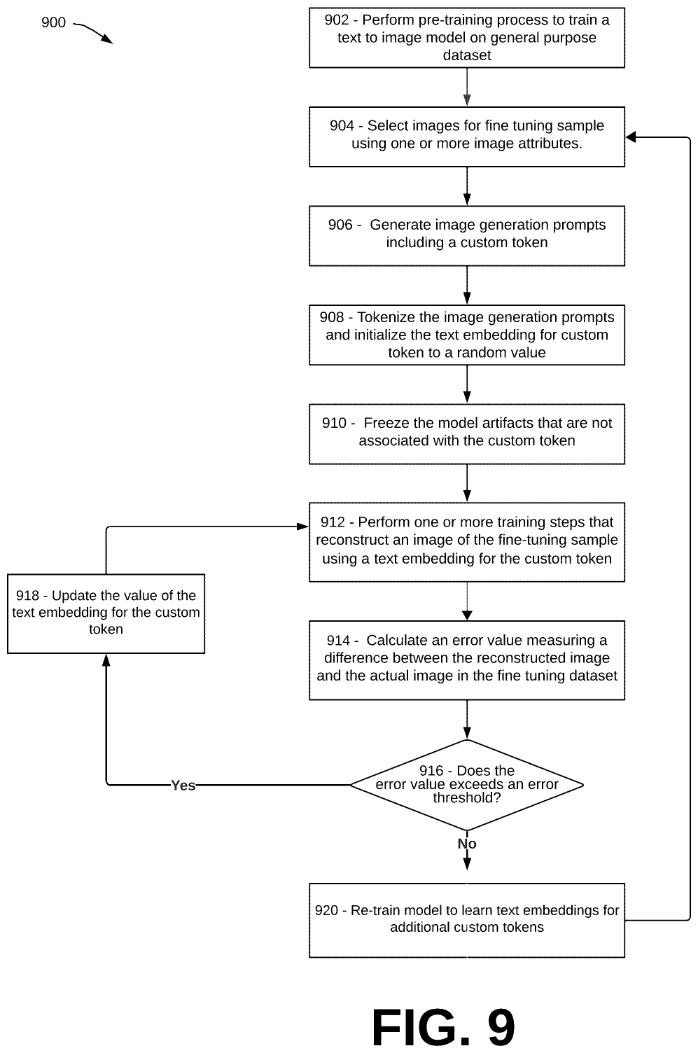

Some present examples also include methods. FIG. 9 is a block diagram of a process 900 of training an image to text model. At step 902, the training service performs a pre-training process to train a text to image model on a general purpose dataset. The pre-training process may provide a pre-trained text to image model that creates images from a natural language description. The natural language description may guide the creation process of the text to image model so that the images created by the text to image model may include objects and visual characteristics that are included in the natural language description.

At step 904, images for a targeted image sample may be selected using one or more image attributes. The targeted image sample may be used to train a constrained text to image model to understand visual characteristics of images included in targeted image sample. At step 906, a prompt generator may generate image generation prompts including a custom token. A unique image generation prompt may be determined for each image in the targeted image sample and the same custom token may be included in each prompt. A selective training process may be performed to determine a text embedding value for the custom token that stores a textual representation of the visual characteristics of the images in the fine tuning sample. The image generation prompts used during the selective training process may have a neural context to maximize the amount of creative guidance attributed to the custom token. By concentrating the conditioning process on the custom token, the selective training process maximizes the number of visual features of the images of the fine tuning sample that are reflected in the text embedding for the custom token.

At step 908, the pre-trained text to image model may tokenize the image generation prompt to map each word included in the prompt to a trained text embedding space. The text embedding for the custom token may be initialized to a random value because the custom token is a pseduo word that does not appear in the trained text embedding space. At step 910, model artifacts that are not associated with the custom token are frozen so that they are not changed during the selective training process. For example, the text embeddings for the other tokens in the image generation prompts, the weights to the denoising network and the weights of the encoder may all be held constant during the training steps of the selective training process. Freezing the model artifacts that are not associated with the custom token (e.g., all of the model artifacts other than the text embedding for the custom token) ensures that the custom token is the only variable artifact trained during the selective training process.

At step 912, the text embedding for the custom token may be determined during the training steps of the selective training process. For each training step, the denoising network may perform an image reconstruction task that reconstructs an original image of the fine tuning sample from a noisy representation of the image produced by the encoder. The denoising network may reconstruct the original image using noisy features (e.g., features that distinguish image data from random noise) embodied in the trained weights of the denoising network and conditional embeddings determined from the text embeddings for each of the tokens of the image generation prompt. At step 914, an error value measuring the difference between the reconstructed image and the original image may be calculated. A gradient is determined from the error value and used to backpropagate the error through the model by adjusting value of the text embedding for the custom token based on gradient. The bigger the difference between the reconstructed image and the original image the larger the error value and gradient and the more the value of the text embedding for the custom token may be adjusted. Since the text embedding for the custom token is the only variable model artifact in the selective training process, the value of the text embedding for the custom token is the only aspect of the model updated after each training step. Multiple training steps may be performed to optimize the value of the text embedding for the custom token.

At step 916, the error value may be compared to an error threshold (e.g., 0.2 of some other pre-determined value). If the error value exceeds the error threshold (yes at step 916), the text embedding for the custom token may be updated based on a gradient determined form the error value at step 918. The text to image model may then be updated by adjusting the value of the text embedding for the custom token to the updated value. Steps 912-916 may be repeated using the updated text to image model to generate a new reconstructed image based on the updated value for the custom token text embedding and determine if the difference between the reconstructed image and the original image is acceptable. If the error value with within the error threshold (no at step 916) the text to image model may be re-trained to learn text embeddings for additional custom token, at step 920. The text to image model may be trained to learn text embeddings for new custom tokens by repeating steps 904-916 using different images for the targeted image sample and a new pseudo word the custom token.

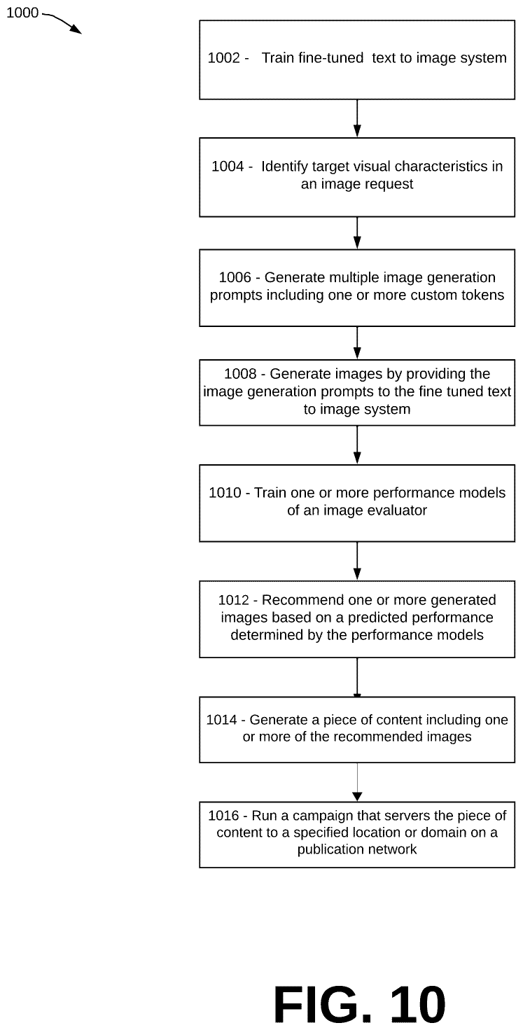

FIG. 10 is a block diagram of a process 1000 of generating images having target visual characteristics. At step 1002 a constrained text to image model is trained as described above in FIG. 9. At step 1004, a prompt generator may identify target visual characteristics that map to image characteristics included in an image request. The image request may be received, for example, from a conversational user interface displayed on a client device. The image request may include one or more pieces of seed data identifying one or more target visual characteristics of a desired image. The prompt generator may parse one or more lines of text and/or user selections included in the image request to identify the target visual characteristics. The identified target visual characteristics may be used to select one or more custom tokens that may be used to generate images having the image characteristics included in the image request. For example, the target visual characteristics may be mapped to one or more token attributes of custom tokens. The token attributes may describe the visual characteristics embodied in each of the custom tokens and the custom tokens may be filtered using the token attributes to select custom tokens that include a textual representation of specific visual characteristics.

At step 1006, the prompt generator may determine image generation prompts including one or more custom tokens. The image generation prompts may be generated by a prompt LM based on seed prompts determined by a seed LM. The image generation prompts may include one or more custom tokens that include a textual representation of the target visual characteristics. At step 1008, the images including the target visual characteristics may be generated by providing the image generation prompts to the fine tuned text to image system. The prompt generator may determine multiple image generation prompts for each image request. The constrained text to image system may generate a unique image for each image generation prompt to create multiple unique images for each image request.

At step 1010, one or more performance models of an image evaluator may be trained. The performance models may determine a predicted performance (e.g., a predicted click through rate or other performance metric) of each of the unique images created by the constrained text to image model. At step 1012, the image evaluator may recommend one or more of the generated images based on a predicted performance determined by the performance models. For example, the image evaluator may rank the images based on the predicted performance (e.g., rank the images in order of the highest predicted click through rate or other performance metric) and recommend a pre-determined number of the highest ranked images (e.g., recommend the five highest ranked images).

At step 1014, the recommended images may be transmitted to a publishing engine that may create a piece of content (e.g., an email, display advertisement, and the like) that includes one or more of the recommended images. The recommended images may also be provided to a publishing system to return the recommended images to the user for review. For example, the recommended images may be displayed in a campaign configuration interface or other GUI provided by the publishing system. At step 1016, the publishing system may run a campaign that servers the pieces of content created by the publishing engine to a specified location or domain on a publication network. For example, an ESP may run a campaign that delivers an email including the piece of content created with the recommended image to one or more email domain servers. In another example a DSP may run a campaign that obtains a placement at a specific location within a webpage and publishes the piece of content created with the recommended image at the obtained placement.

Another process for generating images including a target visual characteristic may include at least the following operations: accessing an image request including a piece of seed data identifying a target visual characteristic; and generating a targeted image dataset based on the piece of seed data. The targeted image dataset may include multiple images with the target visual characteristic. The process may also include inputting the targeted image dataset and a text input (e.g., a language model prompt) including a custom token into a constrained text to image model configured to determine a text embedding for the custom token. The custom token may include a text representation of the target visual characteristic. The constrained text to image model may be configured to determine the text embedding using a training process that determines an optimal value for the text embedding while constraining one or more other trainable aspects of the text to image model to one or more pre-trained values. The process may also include generating, with the constrained text to image model, a target image based on the custom token. The custom token includes a textual representation of the target visual characteristic. The target image may include one or more pixels generated based on the target visual characteristic. For example, the constrained text to image model may generate the target image by generating multiple pixels (e.g., a number of pixels required for a 1024 pixel by 1024 pixel image) to include in the target image based on the text input and the custom token. The constrained text to image model may generate and/or modify one or more of the multiple pixels based on the custom token to ensure the target visual characteristic is included in the target image.

The process may also include determining, with the constrained text to image model, text embeddings for multiple new custom tokens based on multiple new targeted image datasets; accessing a memory storing a visual vocabulary including the multiple new custom tokens; and generating, with the constrained image model, a target image based on one or more of the multiple new custom tokens.

The process may also include determining one or more token attributes for each of the new custom tokens based on one or more image attributes of one or more images included in the new targeted image dataset used to determine each of the new custom tokens.

The process may also include identifying a new target visual characteristics of a desired image from a piece of seed data included in a new image request; matching the new target visual characteristics to a token attribute for at least one of the new custom tokens; and inputting a text input into the constrained text to image model to generate a new target image having one or more pixels generated based on the new target visual characteristic that aligns with the token attribute.

The process may also include inputting multiple different text inputs into the constrained image to text model to generate. The multiple images may include the one or more target visual characteristics and each of the multiple different text inputs may include the custom token. The multiple images may also include a different variation of a subject included in the image request.

The process may also include inputting each of the multiple images into a performance model of an image evaluator configured to determine a ranking for each of the multiple images based on a predicted performance of each of the multiple images; accessing the ranking for each of the multiple images determined by the one or more performance models of an image evaluator; and recommending at least one of the multiple images based on the ranking.

The process may also include generating a piece of content (e.g., a website, display ad, email, and the like) that includes the at least one recommended image; and providing the piece of content to a device configured to display the piece of content at a specific location or domain on a publication network.

The process may also include providing the at least one recommended image to a device configured to display the at least one recommended image in a graphical user interface (GUI) in response to the image request.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PST_{N}), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform operations for generating an image having a target visual characteristic, the operations comprising:
accessing an image request including a piece of seed data identifying a target visual characteristic;
generating a targeted image dataset based on the piece of seed data, the targeted image dataset including multiple images with the target visual characteristic;
inputting the targeted image dataset and a text input including a custom token into a constrained text to image model configured to determine a text embedding for the custom token, the custom token including a text representation of the target visual characteristic, the constrained text to image model configured to determine the text embedding using a training process that determines an optimal value for the text embedding while constraining one or more other trainable aspects of the text to image model to one or more pre-trained values; and
generating, with the constrained text to image model, a target image based on the custom token, the target image including one or more pixels generated based on the target visual characteristic.

2. The system of claim 1, wherein the operations further comprise:
determining, with the constrained text to image model, text embeddings for multiple new custom tokens based on multiple new targeted image datasets;
accessing a memory storing a visual vocabulary including the multiple new custom tokens; and
generating, with the constrained image model, a target image based on one or more of the multiple new custom tokens.

3. The system of claim 2, wherein the operations further comprise determining one or more token attributes for each of the new custom tokens based on one or more image attributes of one or more images included in the new targeted image dataset used to determine each of the new custom tokens.

4. The system of claim 3, wherein the operations further comprise identifying a new target visual characteristics of a desired image from a piece of seed data included in a new image request;
matching the new target visual characteristics to a token attribute for at least one of the new custom tokens; and
inputting a text input into the constrained text to image model to generate a new target image having one or more pixels generated based on the new target visual characteristic that aligns with the token attribute.

5. The system of claim 1, wherein the operations further comprise inputting multiple different text inputs into the constrained image to text model to generate, multiple images including the one or more target visual characteristics, each of the multiple different text inputs including the custom token.

6. The system of claim 5, wherein each of the multiple images include a different variation of a subject included in the image request.

7. The system of claim 5, wherein the operations further comprise inputting each of the multiple images into a performance model of an image evaluator configured to determine a ranking for each of the multiple images based on a predicted performance of each of the multiple images;
accessing the ranking for each of the multiple images determined by the one or more performance models of an image evaluator; and
recommending at least one of the multiple images based on the ranking.

8. The system of claim 7, wherein the operations further comprise generating a piece of content that includes the at least one recommended image; and
provide the piece of content to a device configured to display the piece of content at a specific location or domain on a publication network.

9. The system of claim 7, wherein the operations further comprise providing the at least one recommended image to a device configured to display the at least one recommended image in a graphical user interface (GUI) in response to the image request.

10. The system of claim 1, wherein the custom token includes a textual representation of the target visual characteristic.

11. A method for generating an image having a target visual characteristic, the method comprising:
accessing an image request including a piece of seed data identifying a target visual characteristic;
generating a targeted image dataset based on the piece of seed data, the targeted image dataset including multiple images with the target visual characteristic;
inputting the targeted image dataset and a text input including a custom token into a constrained text to image model configured to determine a text embedding for the custom token, the custom token including a text representation of the target visual characteristic, the constrained text to image model configured to determine the text embedding using a training process that determines an optimal value for the text embedding while constraining one or more other trainable aspects of the text to image model to one or more pre-trained values; and
generating, with the constrained text to image model, a target image based on the custom token, the target image including one or more pixels generated based on the target visual characteristic.

12. The method of claim 11, further comprising:
determining, with the constrained text to image model, text embeddings for multiple new custom tokens based on multiple new targeted image datasets;
accessing a memory storing a visual vocabulary including the multiple new custom tokens; and
generating, with the constrained image model, a target image based on one or more of the multiple new custom tokens.

13. The method of claim 12, further comprising determining one or more token attributes for each of the new custom tokens based on one or more image attributes of one or more images included in the new targeted image dataset used to determine each of the new custom tokens.

14. The method of claim 13, further comprising identifying a new target visual characteristics of a desired image from a piece of seed data included in a new image request;
matching the new target visual characteristics to a token attribute for at least one of the new custom tokens; and
inputting a text input into the constrained text to image model to generate a new target image having one or more pixels generated based on the new target visual characteristic that aligns with the token attribute.

15. The method of claim 11, further comprising inputting multiple different text inputs into the constrained image to text model to generate, multiple images including the one or more target visual characteristics, each of the multiple different text inputs including the custom token.

16. The method of claim 15, wherein each of the multiple images include a different variation of a subject included in the image request.

17. The method of claim 15, further comprising inputting each of the multiple images into a performance model of an image evaluator configured to determine a ranking for each of the multiple images based on a predicted performance of each of the multiple images;
accessing the ranking for each of the multiple images determined by the one or more performance models of an image evaluator; and
recommending at least one of the multiple images based on the ranking.

18. The method of claim 17, further comprising generating a piece of content that includes the at least one recommended image; and
providing the piece of content to a device configured to display the piece of content at a specific location or domain on a publication network.

19. The method of claim 17, further comprising providing the at least one recommended image to a device configured to display the at least one recommended image in a graphical user interface (GUI) in response to the image request.

20. The method of claim 11, wherein the custom token includes a textual representation of the target visual characteristic.
